(19) United States
(12) Patent Application Publication
(10) Pub. No.: US 2025/0143488 A1
(43) Pub. Date: May 8, 2025

(54) PICTURE FRAME

(71) Applicants: E. Morrish LTD, Newtown (GB); Millbrook Mouldings Limited, Newtown (GB); John Morrish Limited, Newtown (GB)

(72) Inventors: Edward Glenn Morrish, Newtown (GB); Mark Peter Morrish, Newtown (GB); John Morrish, Newtown (GB)

(21) Appl. No.: 18/939,225

(22) Filed: Nov. 6, 2024

(30) Foreign Application Priority Data
Nov. 7, 2023 (GB) 2317102.8

(51) Int. Cl. A47G 1/06

(52) U.S. Cl. CPC A47G 1/0633

(57) ABSTRACT

A picture frame comprising a picture carrier portion and a frame portion, the frame portion for formation of a frame and comprising frame members with: a side member hingedly connected via a first hinge connection to the picture carrier portion; a back member hingedly connected via a second hinge connection to the side member, wherein in an assembled configuration: the side member forms an side of the frame; the back member forms a back of the frame and is inclined relative the carrier portion to extend from the side member to the picture carrier portion.

### CROSS-REFERENCE TO RELATED APPLICATIONS

This application claims benefit under 35 U.S.C. § 119(a) of GB Application No. 2317102.8, filed Nov. 7, 2023, titled “Picture Frame”; the entire contents of which are hereby expressly incorporated herein by reference.

### BACKGROUND

The present disclosure relates to a picture frame to frame a picture.

Picture frames provide a protective edging and mounting for a picture, which can include a painting or photograph. The picture frame can be configured to attach to a wall and/or to stand on a surface. It is becoming increasingly popular to display pictures with picture frames, particularly since users of mobile phones frequently take pictures with such devices.

A conventional picture frame is made of wood or metal. Such frames can be expensive to produce due to the expense of the materials required. They may also be time consuming to fit to a picture, for example, the picture may have to be cut to a particular size and/or mounted to a carrier, which is then clamped to the frame. Conventional picture frames are therefore not suitable for mass production.

Therefore, despite the effort already invested in the development of said picture frames further improvements are desirable. In particular, it is desirable to provide a cost-effective picture frame that is suitable for mass production.

### SUMMARY

The present disclosure provides, a picture frame comprising a picture carrier portion and a frame portion. The frame portion is configured for formation of a frame (e.g. on the picture carrier member) and comprises frame members with: a side member hingedly connected via a first hinge connection to the picture carrier portion; a back member hingedly connected via a second hinge connection to the side member.

In embodiments, in an assembled configuration: the side member forms (including fully or partially) a side of the frame portion; the back member forms (including fully or partially) a back of the frame portion.

In embodiments, the back member in the assembled configuration is inclined (e.g., not parallel, or perpendicular thereto, but oblique) relative the picture carrier portion.

In embodiments, in the assembled configuration, the back member extends between the side member (e.g., including via a direct or indirect connection via an intermediate member to the side member) and the picture carrier portion (e.g., including via a direct or indirect connection via an intermediate member to the picture carrier portion member). For example, a plane of the back member may intersect and have an incline to plane of the picture carrier member, and/or the back member may extend entirely between the picture carrier member and the side member

By implementing the back member to connect at an angle to the picture carrier portion, an alternative configuration of a separate back member and a perpendicular thereto inner side member may be obviated, which may simplify assembly and construction of the blank. Moreover, the resultant assembled structure may be more inherently stable since it implements a triangular rather than a rectangular section.

As used herein the term “side member” may refer to a member that is angled either at 90 degrees (including substantially 90 degrees) or is inclined (e.g., at to up to ±10-±20 degrees to a normal to the picture carrier member) to the picture carrier member. An outer face of the side member forms, e.g., fully or partially, a side, e.g., an outer periphery, of the assembled frame portion of the picture frame. Other members, e.g., the picture member, maybe at least partially disposed over the side member to form a side of the assembled picture member and picture frame.

As used herein the term “back member” may refer to a member that has an outer face that forms, e.g., fully or partially, a back of the frame portion of the picture frame. Other members, e.g., a closing back member and/or the picture member maybe at least partially disposed over the back member to form a back of the assembled picture member and picture frame.

As used herein the term “hingedly connected” may refer to a pivoted connection that can either be formed along a weakening line in the material, or dedicated pivot mechanism or other suitable arrangement.

As used herein the term “hinged connection” may refer to a direct connection between the associated picture carrier member and side member and the side member and back member, or a like connection with an intermediate member there between. For example, the second hinged connection may refer to an intermediate member hingedly connected to the side member and hingedly connected to the back member, and in the assembled configuration the intermediate member may be arranged perpendicular (including substantially perpendicular) to the side member and inclined to the back member. The definition may apply for other hinged connections, as disclosed herein, including the third hinged connection as will be discussed.

As used herein the term “assembled configuration” may refer to a configuration in which the picture frame as at least partially assembled, e.g. with assembly of the frame portion. A disassembled configuration may refer to the picture frame arranged as a blank, including a planar blank.

As used herein the term “extend between the side member and the carrier portion”, in respect of the back member, may refer to the full or partial extension (e.g., with an intermediate member) of the back member between the side member and the picture carrier portion.

In embodiments, in the assembled configuration the back member is inclined relative the carrier portion with an interior angle that is 5-60 or 2.5-80 degrees, or about 15 degrees or with an interior angle that is acute. Such an angle range may provide effective structural rigidity.

In embodiments, the frame portion includes a carrier portion connecting member, which is connected via a third hinge connection (e.g. directly or via an intermediate member) to the back member. In the assembled configuration, the carrier portion connecting member is configured to connect the back member to the picture carrier portion. By implementing a carrier portion connecting member to connect to the picture carrier portion, and thereby secure the back member thereto the frame portion may be conveniently assembled.

In embodiments, in the assembled configuration the carrier portion connecting member configured/arranged to extend from the back member away from the side member. By implementing the carrier portion connecting member to extend towards a centre of the picture carrier portion (e.g. as opposed to being folded inwards), the frame may be more convenient to assemble. For example, a user or machine may grab the carrier portion connecting member (or a further member connected thereto) and rotate it to the assembled configuration. More accurate assembly may also be facilitated since the carrier portion connecting member may be precisely located on an exposed portion of the picture carrier portion.

In embodiments, in the assembled configuration, the carrier portion connecting member extends planar to the picture carrier portion. By implementing the carrier portion connecting member to sit flat against the picture carrier portion, a convenient and secure assembly may be achieved.

In embodiments, the carrier portion connecting member and picture carrier portion are configured to be adhesively connected to each other in the assembled configuration. An adhesive, rather than a stable or other mechanical faster, may not disrupt a front face of the picture carrier member that abuts a picture member.

In embodiments, the frame portion includes a guide tab, which may be is holdable by a user/or an assembly machine, to manipulate the carrier portion connecting member/back member to the assembled configuration. For example, the guide tab has a width on at least 5 mm in the direction normal to the hinged connection so that it may be adequately held and manipulated. In embodiments, the guide tab is connected (e.g. via a fourth hinge connection) to the carrier portion connecting member or the back member. By implementing a guide tab, the carrier portion connecting member/back member may be conveniently manipulated into the assembled configuration.

In embodiments, the picture carrier portion comprises indications to define a position of the carrier portion connecting member/back member in the assembled configuration. By implementing markings on the picture carrier portion, a position for the carrier portion connecting member in the assembled configuration may be precisely identified.

In embodiments, in the assembled configuration adjoining carrier portion connecting members are arranged to interlock with each other. By implementing adjoining carrier portion connecting members to fit together with each other (e.g. one of the carrier portion connecting members defines at least part of a cavity, which may be defined in combination with the back member, that the adjoining carrier portion connecting member fits in), secure and convenient assembly may be achieved.

In embodiments, the frame portion has the side portion formed only of the side member and the back portion formed only of the back member, e.g., with no intermediate members, such that the side and back members are planar, including substantially planar.

In embodiments, adjoining sides of the frame portion are arranged in the assembled configuration with the back members to connect to each other. By connecting the back members to each other, e.g., at their ends, including directly to abut at their edges and/or via an intermediate member, secure and convenient assembly may be achieved.

In embodiments, a back member includes a back member connecting member, which is arranged to connect to an adjoining back member in the assembled configuration. By implementing a back member connecting member at an end of a back member to connect to an end of an adjoining back member, secure and convenient assembly may be achieved. In embodiments, the back member connection member is arranged at a tip (e.g. an end which is not connected to the side member) of the back member.

In embodiments, a hinged connection is implemented between the back member connecting member and the back member. In embodiments, the hinged connection is angled to angle the back member connecting member to correspond to said incline of the adjoining back member in the assembled configuration.

By implementing a hinged connection at an angle, e.g. the angle of the corner, between the back member connecting member and the back member, it may be ensured that the back member connecting member can be arranged planar to the adjoining back member in the assembled configuration.

In embodiments, the back member connecting member and adjoining back member are configured for adhesive connection to each other.

In embodiments, adjoining back members are configured to interlock with each other in the assembled configuration. By arranging adjoining back members to fit together and/or overlap each other, secure and convenient assembly may be achieved.

In embodiments, corresponding engagement portions, which are arranged proximal the side members, of the adjoining back members abut each other along respective edges in the assembled configuration. By arranging the edges of adjoining back members to abut each other along their edges at a position proximate the side members, secure and convenient assembly may be achieved.

In embodiments, the adjoining back members overlap each other distal the engagement portions. By arranging the adjoining back members overlap each other as well as abut each other, secure and convenient assembly may be achieved, for example overlapping may permit secure connection with the back member connecting member.

In embodiments, a cut-out portion is disposed between the engagement portion and said overlap. By implementing a cut-out portion, a convenient transition between portions of adjoining back members that overlap and abut may be achieved.

In embodiments, an adjoining back member comprises indications to define a position of the back member connecting member in the assembled configuration. By implementing markings on the adjoining back member, a position for the back member connecting member in the assembled configuration may be precisely identified.

In embodiments, the picture frame is formed as a blank from sheet material, e.g., paperboard or fibreboard. A blank may enable cost effective/mass production of the picture frame. For example, it may be cut and/or stamped from sheet material.

### System

The present disclosure provides a picture frame of any of the preceding embodiments, or another embodiment disclosed herein and a corresponding picture member and/or a closing back member.

In embodiments, the picture frame is arranged in an assembled configuration, with the picture member connected to one or more of the: frame portion (e.g., the side member and/or the back member); the picture carrier portion.

In embodiments, the picture member is connected to the picture frame with fixing system (e.g., a staple and/or adhesive).

In embodiments, the closing back member is arranged to fit within a cavity, which is at least partially bounded/formed by the back members (including with the picture member over the back members) in the assembled configuration.

In embodiments, the closing back member is formed from sheet material and is arrangeable in an assembled configuration in which grooves at corners of said sheet permit aligning of peripheral members to an angle to correspond to said incline of the back members.

By implementing the peripheral members to be angled at a same (including substantially the same) angle as the back members in the assembled configuration, secure and convenient assembly may be achieved.

In embodiments, the closing back member comprises the groves arranged on an interior face. By arranging the grooves on the interior face, e.g., the face that faces into the cavity, the grooves may not be visible from an exterior of the assembly.

In embodiments, the groves extend from a corner of the closing back member. In embodiments, the grooves extend longitudinally along the peripheral members.

### Use

The present disclosure provides use of the picture frame of any preceding embodiment, or another embodiment disclosed herein, for mounting a picture member.

The present disclosure provides use of the picture member of any preceding embodiment, or another embodiment disclosed herein, for the picture frame any preceding embodiment, or another embodiment disclosed herein.

### Method

The present disclosure provides, a method of assembling a picture frame. In embodiments, the method comprises: hinging a first hinge connection to hinge a side member relative to a picture carrying portion; hinging a second hinging connection to hinge a back member relative the side member, and; connecting the back member to the picture carrier member at an incline thereto.

In embodiments, the method comprises arranging the back member at an incline to the picture carrier member by connecting a carrier portion connecting member to the picture carrier member. In embodiments, the method comprises arranging the carrier portion connecting member to extend from the back member away from the side member.

In embodiments, the method comprises connecting adjoining back members in the assembled configuration with a back member connecting member. In embodiments, the method comprises implementing a hinged connection between the back member connecting member and one or the back members to effect said connection.

In embodiments, the method comprises connecting the picture member to the frame portion prior to hinging said hinge connections, e.g., into the assembled configuration. In embodiments, the method comprises connecting the picture member to the side member, and/or the back member.

The present disclosure provides, a method of forming the picture frame as a blank from sheet material. The picture frame may implement the features of any preceding embodiment or another embod9ment disclosed herein.

The preceding summary is provided for purposes of summarizing some embodiments to provide a basic understanding of aspects of the subject matter described herein. Accordingly, the above-described features are merely examples and should not be construed to narrow the scope or spirit of the subject matter described herein in any way. Moreover, the above and/or proceeding embodiments may be combined in any suitable combination to provide further embodiments. Other features, aspects, and advantages of the subject matter described herein will become apparent from the following Detailed Description, Figures, and Claims.

### BRIEF DESCRIPTION OF FIGURES

Aspects, features and advantages of embodiments of the present disclosure will become apparent from the following description of embodiments in reference to the appended drawings in which like numerals denote like elements.

FIGS. 1-7 are to scale back/top perspective views showing an embodiment picture frame, which are arranged in order of an embodiment assembly process.

FIG. 8 is a to scale back perspective view showing an embodiment picture member for the picture frame of FIGS. 1-7.

FIG. 9 is a to scale back perspective view showing an embodiment closing back member for the picture frame of FIGS. 1-7.

FIGS. 10 and 11 are to a scale back/top perspective views showing an assembly of: the picture frame of FIG. 7 in an assembled configuration, and; the closing back member of

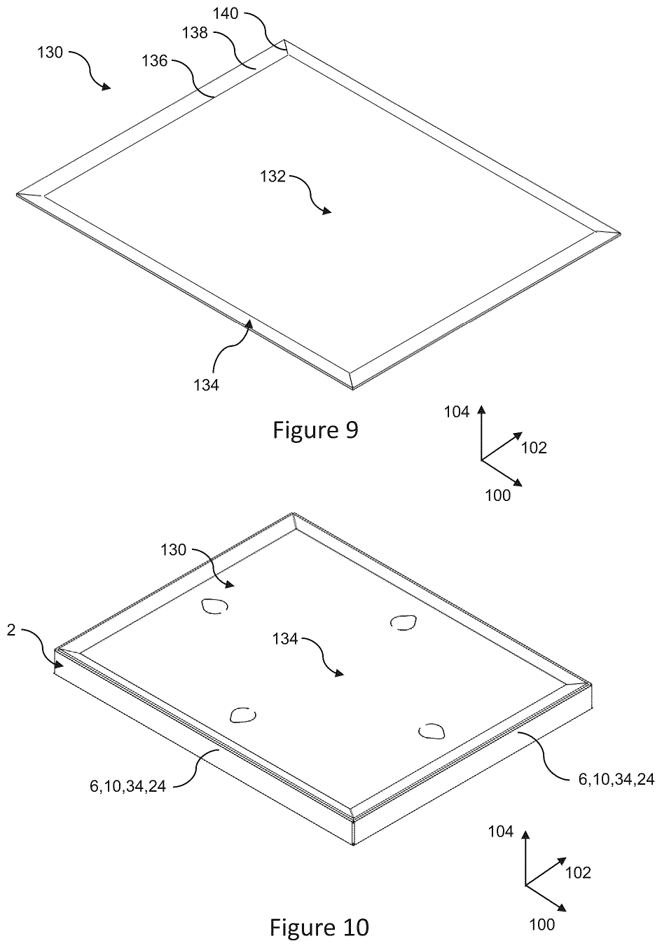

FIG. 9 in an assembled configuration.

### DETAILED DESCRIPTION

Before describing several embodiments of the picture frame assembly, it is to be understood that the picture frame assembly is not limited to the details of construction or process steps set forth in the following description. It will be apparent to those skilled in the art having the benefit of the present disclosure that the system is capable of other embodiments and of being practiced or being carried out in various ways.

The present disclosure may be better understood in view of the following explanations:

As used herein the term “picture” or “picture member” may refer to an item comprising a picture article that is suitable for display with a picture frame, it can include: a photo; artwork that can include a painting; or other article. The picture article may comprise a picture face that presents the picture and a back face which is on an opposed face to the picture face. The picture member may include a carrier, e.g. a backing substrate, to support the picture article, which may be arranged behind the picture article when supported. The picture article and the carrier may be integrally formed, e.g. the picture article is printed onto the carrier. The picture member may be arranged to wrap around a frame portion of the picture frame or just to be connected to a picture carrier portion.

As used herein the term “picture frame” may refer to a support structure for the picture member The picture frame may be formed by any suitable technique for forming a structure from the relevant material. For a plastic based material, it may be formed by one or more of: injection moulding; extrusion; machining from a solid material; other forming process. For a paperboard or fibreboard material, it may be formed by stamping/cutting of a blank from a sheet. The picture frame may be arranged to support pictures of size of about 8×8 to 5×7 to 12×12 inches. The picture frame can include a frame portion and a picture carrier portion that can be separable or integrally formed.

As used herein the term “frame portion” may refer to a portion of the picture frame that implements a frame at the edges of the picture member.

As used herein the term “picture carrier portion” may refer to a portion of the picture frame that presents a generally planar face to support/carry a picture member.

As used herein the term “sheet material” may refer to a material arrangement with a comparatively thin thickness and a large in-plane length and width. The sheet material may be supplied as individual sheets or as a continuous web. From each individual sheet/web one or a plurality of blanks can be at least partially formed. Examples include: paperboard; fibreboard; plastic; metal base foil; laminates of the aforesaid.

As used herein the term “paperboard” or “cardboard” may refer to a paper pulp-based board. A thickness of the material may be greater than 0.30 mm and/or a grammage of a grammage above 250 g/m², hence to distinguish the material from paper. Paperboard may be single-ply or multi-ply.

As used herein the term “fibreboard” may refer to a wood product that is made from wood fibres or a kraft-based paperboard. It may include a kraft-based paperboard or corrugated fibreboard.

### General Components of Picture Frame

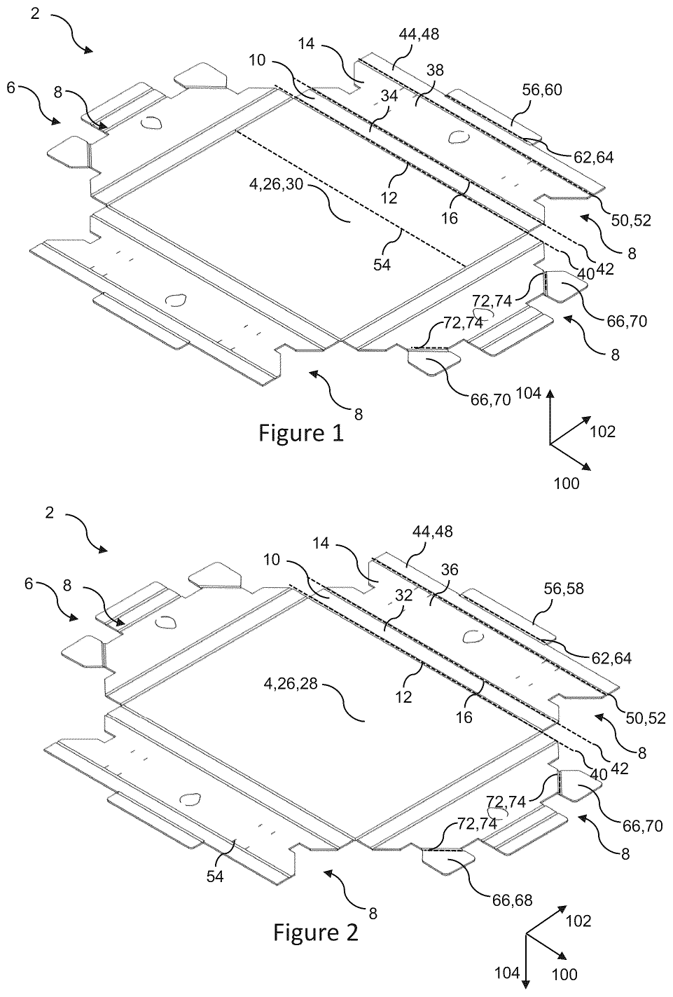

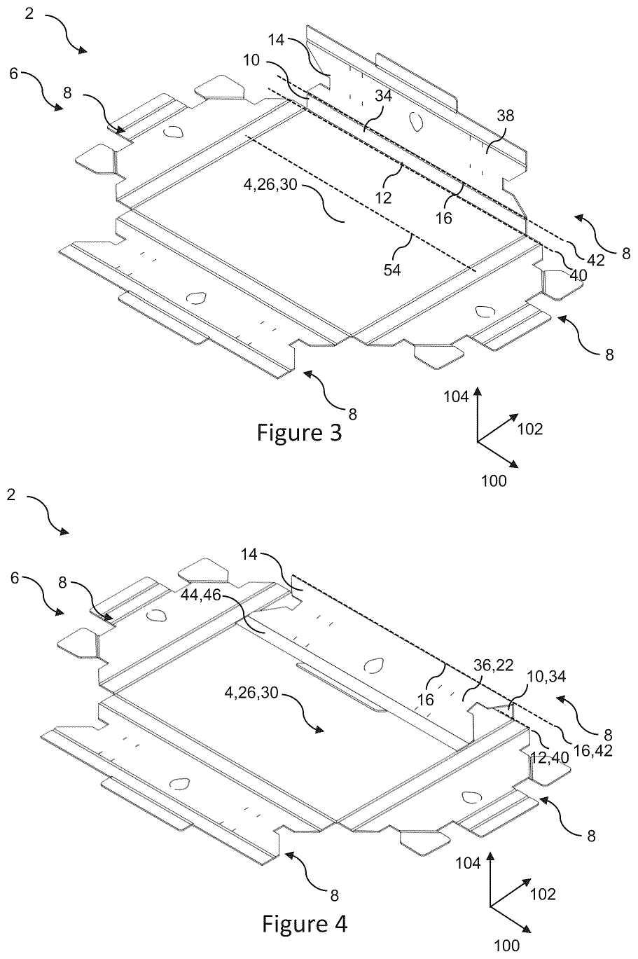

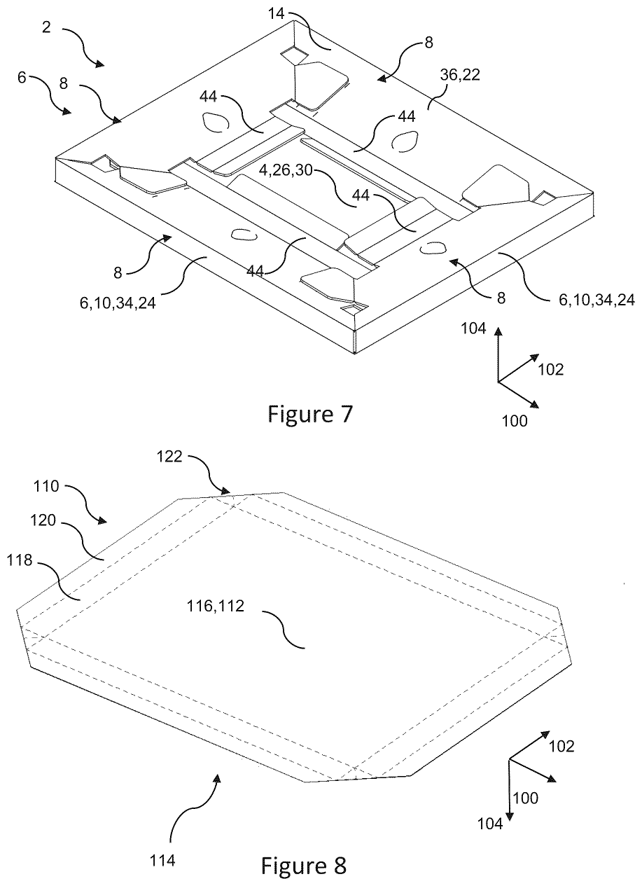

Referring to FIGS. 1 and 2, a picture frame 2 in a disassembled configuration is illustrated. FIGS. 3-6 illustrate the picture frame 2 in a partially assembled configuration, with various stages of assembly. FIGS. 7, 10 and 11 illustrate the picture frame 2 in an assembled configuration.

The picture frame 2 includes a picture carrier portion 4 and a frame portion 6. The frame portion 6 is for formation of a frame around the picture carrier portion 4.

The frame portion 6 comprises four frame members 8, each of which comprise: a side member 10 hingedly connected via a first hinge connection 12 to the picture carrier portion 4; a back member 14 hingedly connected via a second hinge connection 16 to the side member 10.

In the unassembled configuration shown in FIGS. 1 and 2, the picture carrier portion 4 and a frame portion 6 are aligned in an in-plane direction, which is defined by a longitudinal direction 100 and a lateral direction 102, which are both orthogonal to a depth direction 104.

Referring to FIGS. 7, 10 and 11, the picture frame 2 in the assembled configuration the picture frame 2 includes an exterior front 20 a back 22, and a side 24. The side member 10 forms the side 24 of the picture frame 2; the back member 14 forms the part of the back 22 of the of the picture frame 2 (together with a back face of the picture carrier portion 4 as will be discussed). Referring to FIG. 7, the back member 14 is inclined relative the picture carrier portion 4 and extends fully from the side member 10 to the picture carrier portion 4.

In variant embodiments, which are not illustrated, an intermediate member is interposed between the back member 14 and the carrier portion 4 and/or the side member 10, such that the back member 14 is inclined relative the picture carrier portion 4 and extends partially from the side member 10 to the picture carrier portion 4.

### Picture Carrier Portion

Referring to FIGS. 1 and 2, the picture carrier portion 6 includes a planar body 26 that has a front face 28 and a back face 30, both of which are aligned to a plane arranged in the longitudinal 100 and lateral 102 directions. The body 26 is rectangular, with the elongate direction aligned to the longitudinal 100 direction.

In variant embodiments, which are not illustrated: the picture carrier portion is alternatively shaped, including as rhomboid or triangular or hexagonal or other suitable shape (with a number of frame members adapted to correspond to the numbers of sides of said shape).

### Frame Portion

Although the following description for brevity initially refers to a single right side frame member 8 (which extends in the longitudinal direction 100 with the greatest lateral position 102), it will be appreciated that the description applies to all four frame members, which comprise: a left side longitudinal frame member 8 (which extends in the longitudinal direction 100 with the least lateral position 102); a top lateral frame member 8 (which extends in the lateral direction 102 with the least longitudinal position 100), and; a bottom lateral frame member 8 (which extends in the lateral direction 102 with the greatest longitudinal position 100). Moreover, to preserve clarity in the figures, where appropriate corresponding features of other of frame members are numbered.

Referring to FIGS. 1 and 2, the side member 10 have a front face 32 and a back face 34. The back member 14 have a front face 36 and a back face 38. The side member 10 and back member 14 are planar (including substantially planar) in both the unassembled and assembled configurations.

Referring to FIG. 4, with the right longitudinal frame members 8 of the frame portion 6 only in the assembled configuration, in which: the side member 10 is hinged at the first hinged connection 12 with an interior angle (e.g. by interior it is meant the angle within the closed triangle section formed by said members) of 90 degrees to the picture carrier portion 4 the front face 32 of the side member 10 forms the side 24 (as shown in FIG. 7) of the picture frame 2, and; with back member 14 hinged at the second hinged connection 16 with an interior angle of 75 degrees to the side member 10 and with an interior angle of 15 degrees to the picture carrier portion 4, the back member 14 forms the back 22 of the frame 2.

In variant embodiments, which are not illustrated: the side member is arranged at other angles than an interior angle of 90 degrees to the picture carrier portion e.g., to give a tapered appearance, including at up to ±10-±20 degrees to a normal to the picture carrier member; the back member is arranged at other interior angles to the picture carrier portion, e.g., at any angle greater than 2.5 or 5 or 10 degrees and/or and any angle less than 80 or 60 or 45 or 30 or 20 degrees, generally the angle is acute and for stability is less that the interior angle between the back member and the side member.

### Hinged Connection

Referring to FIGS. 1 and 2, the first hinged connection 12 is arranged in the unassembled configuration, in which the side member 10 and picture carrier portion 4 are arranged in the same longitudinal 100 and lateral 102 extending plane.

Referring to FIG. 3 the first hinged connection 12 is arranged in the assembled configuration, in which the side member 10 is rotated through 90 degrees such that it is arranged in a longitudinal 100 and depth 104 extending plane, and picture carrier portion 6 remains in the longitudinal 100 and lateral 102 extending plane.

The first hinged connection 12 is formed by a line of weakening, which may comprise one or more of: a cut-out; scoring; perforation, including a series of separated perforations along said line; a fold line; other suitable arrangement.

In variant embodiments, which are not illustrated, the hinge connection is alternatively formed by an indicator line or other marking, which indicates to a user where to implement a fold during assembly.

The above description and associated embodiments also apply for the other hinge connections, which for brevity are not described separately.

### Carrier Portion Connecting Member and Guide Tab

Referring to FIGS. 1 and 2, the frame portion 6 includes a carrier portion connecting member 44. The carrier portion connecting member 44 includes a front face 46 and a back face 48. The carrier portion connecting member 44 is connected via a third hinge connection 50, with a hinge axis 52 to the back member 14.

Referring to FIG. 4, with the right side frame member 8 in the assembled configuration, the carrier portion connecting member 44 is configured to connect the back member 14 to the picture carrier portion 4. In the assembled configuration, the carrier portion connecting member 44 extends planar to the picture carrier portion 4, such that the back face 48 (shown in FIG. 1) of the carrier portion connecting member 44 abuts the back face 30 of the picture carrier member 4.

The carrier portion connecting member 44 is connected to the picture carrier portion 4 by a connection system, which is implemented as adhesive. In variant embodiments, other implementations include mechanical fasteners, e.g., staples.

Referring to FIGS. 1 and 3, the picture carrier portion 4 comprises indications 54 to define a position of the carrier portion connecting member 44 in the assembled configuration. The indications are implemented as lines that are intended to align with a peripheral edge of the carrier portion connecting member 44.

Referring to FIG. 7, with all four frame members 8 in the assembled configuration, adjoining carrier portion connecting members 44 are arranged to interlock with each other. In particular, the carrier portion connecting members 44 of the top and bottom frame members 8 are interposed by the ends of the carrier portion connecting members 44 of the left and right frame members 8.

In variant embodiments, which are not illustrated, the carrier portion connecting members may have other arrangements in the assembled configuration, e.g., with the carrier portion connecting members of the left and right frame members interposed by the ends of the carrier portion connecting members of the top and bottom frame members.

Referring to FIGS. 1 and 2, the frame portion 6 includes a guide tab 56. The guide tab 56 includes a front face 58 and a back face 60. The guide tab 56 is connected via a fourth hinge connection 62, with a hinge axis 64 to the carrier portion connecting members 44.

The guide tab 56 is holdable/graspable (e.g., by opposed digits of a hand of a user) to manipulate the carrier portion connecting member 44 to the assembled configuration on the picture carrier member 4.

In particular, the guide tab 56 protrudes outwardly from the carrier portion connecting member 44 and picture carrier member 4 to facilitate said positioning. Moreover, the guide tab 56 has a lesser longitudinal length than the carrier portion connecting member 44 to enable the indications 54 to be observed relative the carrier portion connecting member 44.

In variant embodiments, which are not illustrated: the guide tab is omitted; the carrier portion connecting member is omitted, e.g., the back member connects directly to the picture carrier portion including via adhesive, the guide tab may still be present in such an example; the indications on the picture carrier member may be alternatively implemented or omitted.

### Back Member Connecting Member

Referring to FIGS. 1 and 2, the top and bottom frame portions 6 include, at opposed ends, back member connecting members 66. The back member connecting members 66 include a front face 68 and a back face 70. The back member connecting members 66 are connected via a fifth hinge connection 72, with a hinge axis 74 to the top and bottom back members 14. The back member connecting members 66 are arranged to connect the top and bottom back members 14 to adjoining (e.g., those neighbouring/at the corner of the picture frame) the left and right back member 14 in the assembled configuration.

The fifth hinged connection 72 is angled so that the back member connecting members 66 is angled to correspond to the incline of the left and right adjoining back members in the assembled configuration (e.g., so that they are planar to each other). Referring to FIG. 6, the angle is aligned to the corner axis 76 of the adjoining frame members 6. In the assembled configuration, the back member connecting members 66 extend planar to the adjoining back member 14, such that the back face 70 (as shown in FIGS. 1 and 2) of the back member connecting member 66 abuts the front face 36 of the adjoining back member 14.

The back member connecting members 66 are connected to the adjoining back member 14 by a connection system, which is implemented as adhesive. In variant embodiments, other implementations include mechanical fasteners, e.g., staples.

Referring to FIG. 2, the font face 36 of the left and right back portions 14 comprises indications 54 to define a position of the back member connecting member 66 in the assembled configuration. The indications are implemented as lines that are intended to align with a peripheral edge of the back member connecting member 44.

Referring to FIG. 6, the adjoining back members 14 are configured to interlock along a corner axis 76 (which is arranged at 45 degrees to the longitudinal direction 100 and the lateral direction 102, and is normal to the depth direction 104), with each other in the assembled configuration.

The back members 14 include corresponding engagement portions 78, which are arranged to adjoin the side members 10. The engagement portions 78 abut each other along respective edges along the corner axis 76 in the assembled configuration.

Disposed between the engagement portion 78 and the back member connecting member 66 is a cut-out/transition portion 80.

Since for adjoining back members 14: the engagement portions 78 abut each other along respective edges at the corner axis 76 in the assembled configuration, and; the back member connecting members 66 overlap the adjoining back members, the cut-out/transition portions 80 facilitate the transition from abut to overlap.

In variant embodiments, which are not illustrated: the back member connection member is omitted e.g., the back members do not connect to each other; back member connection members are alternatively arranged, e.g., on the left and right back members or only with one per back member; the indications on the back member connecting member may be alternatively implemented or omitted; the corner axis is alternatively angled.

### Picture Member

The picture frame 2 is assembled in the assembled configuration to carry a picture member 110.

Referring to FIG. 8, in the unassembled configuration, the picture member 110 includes a front face 112 and a back face 114.

The picture member 110 includes: a central picture portion 116 to overlap the picture carrier portion 4; side member regions 118 to overlap the side members 10, and; back member regions 120 to overlap the back members 14, and; corner regions 122, which extend between adjoining side members 10 as a flap that can be folded inwardly during assembly, as will be discussed.

The back member regions 120 are connected to the back members 14 with the aforedescribed connection system.

In variant embodiments, which are not illustrated: the picture member is alternatively connected to the picture frame, e.g. by one or more of the: picture portion; side member regions, and the back member regions; the corner regions may be absent, such that no inward folding is required.

### Closing Back Member

Referring to FIGS. 9 and 10, a closing back member 130 is arranged to fit within a cavity of the picture frame 2, which (as shown in FIG. 7) is: partially bounded/defined by the front face 36 of the back members 14 in the assembled configuration, and; has a base partially defined by the back face 30 of the picture carrier portion 4 (and also the optional carrier portion connecting member 44/guide tab 56 etc).

The closing back member 130 is formed from sheet material, e.g., paperboard, and has a front face 132 and a back face 134. The front face 132 includes longitudinal and lateral grooves 136 that define peripheral members 138. Corner grooves 140, which extend from a peripheral vertex of the closing back member 130, define adjoining ends of the peripheral members 138.

The grooves 136, 140 permit the peripheral members 138 to move to an assembled configuration, in which the peripheral members 138 are angled to correspond to the angle of the back members 14 in the assembled configuration.

Referring to FIG. 10, with the closing back member 130 in the assembled configuration and the picture frame 2 in the assembled configuration, the front face 132 (as shown in in FIG. 9) of the peripheral members 138 abuts and is planar to the front face 36 (as shown in in FIG. 7) of the back members 14.

The peripheral members 138 of the closing back member 130 are connected to the back members 14 by a connection system, which is implemented as adhesive. In variant embodiments, other implementations include mechanical fasteners, e.g., staples.

In embodiments, the closing back member provides a cleaner appearance for the back of the picture frame, rather than structural support for the frame members per se.

In variant embodiments, which are not illustrated: the grooves are omitted, e.g. indicators may be present for the user to implement fold lines; the grooves are alternatively implemented, e.g. on the back face or as fold lines or as periodic perforations; the closing back member is omitted.

### Method of Assembly

Step 1: Referring to FIGS. 1 and 8, the picture member 110 is arranged over the picture frame 2, with the picture carrier portion 4 and a frame member 8 aligned in an in-plane direction in the unassembled configuration. With the back face 114 of the picture member 110 abutting the front face of the picture frame 2, staples are implemented to connect the back portions 120 to the back members 14.

Step 3: The picture frame 2 is moved from the unassembled configuration (FIGS. 1 and 2) initially to the partially assembled configuration of FIG. 3, wherein for the right frame member 8, the side member 10 is rotated at the first hinge connection 12 through 90 degrees to the picture carrier portion 4.

Step 4: Referring to FIG. 4, for the right frame member 8, the back member 14 is rotated at the second hinge connection 12 through 105 degrees to the side member 10. The guide tab 56 is used to position the carrier portion connecting member 44 on the picture carrier portion 4, and is adhered thereto.

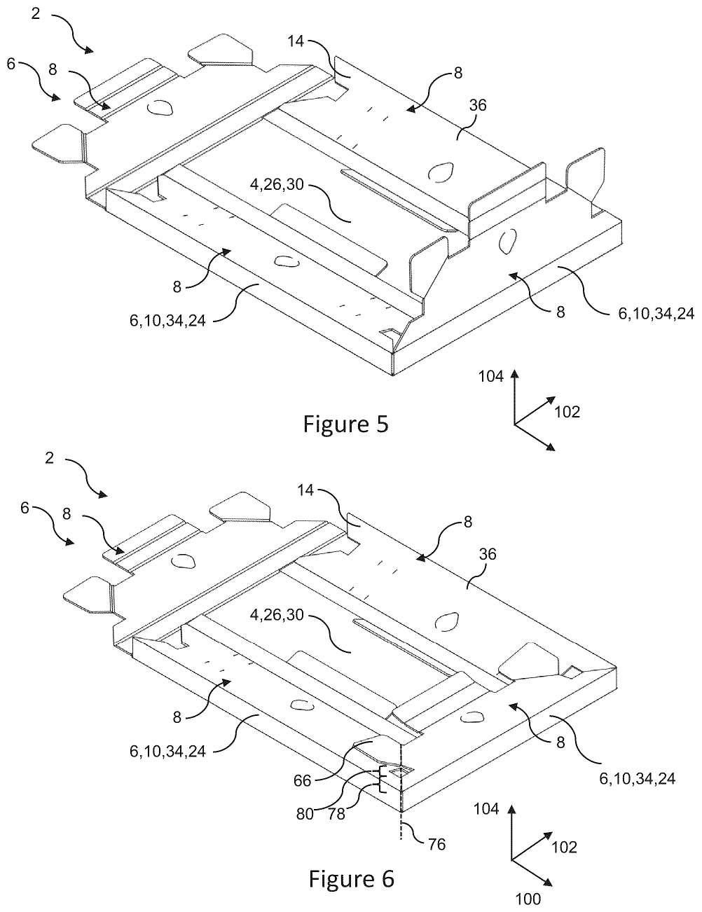

Step 5: Referring to FIGS. 5 and 6, the processes of steps 3 and 4 are repeated for the left frame member 8 and for the top and bottom frame members 8.

Step 6: Referring to FIGS. 6 and 7, the back member connecting member s 66 are rotated at the fifth hinge connection 72 and are adhered to the adjoining back members 14. As adjoining frame members are hinged inwardly, the flap of the picture member 110 that extends between adjoining side members 10 is folded inwardly during to conceal a corner of the picture member.

Step 7: Referring to FIG. 9, the closing member 130 is moved to the assembled configuration.

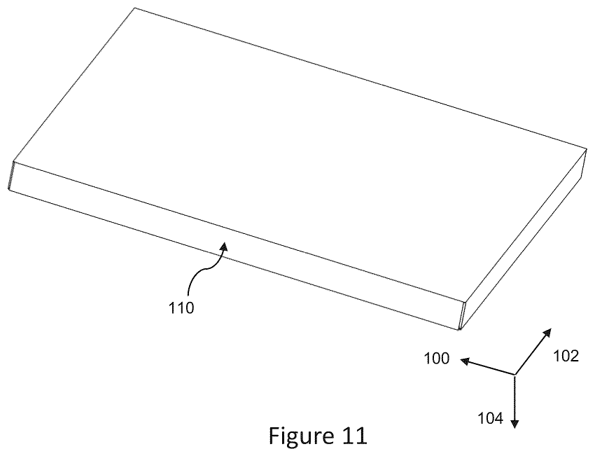

Step 8: Referring to FIGS. 10 and 11, the closing member 130 is connected to the picture frame 2 by adhering the peripheral side members 138 to the back members 14.

Variants of the above method maybe impended, e.g., to account for the aforedescribed variant embodiments in the description.

As used in this specification, any formulation used of the style “at least one of A, B or C”, and the formulation “at least one of A, B and C” use a disjunctive “or” and a disjunctive “and” such that those formulations comprise any and all joint and several permutations of A, B, C, that is, A alone, B alone, C alone, A and B in any order, A and C in any order, B and C in any order and A, B, C in any order. There may be more or less than three features used in such formulations.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

Unless otherwise explicitly stated as incompatible, or the physics or otherwise of the embodiments, example or claims prevent such a combination, the features of the foregoing embodiments and examples, and of the following claims may be integrated together in any suitable arrangement, especially ones where there is a beneficial effect in doing so. This is not limited to only any specified benefit, and instead may arise from an “ex post facto” benefit. This is to say that the combination of features is not limited by the described forms, particularly the form (e.g. numbering) of the example(s), embodiment(s), or dependency of the claim(s). Moreover, this also applies to the phrase “in one embodiment”, “according to an embodiment” and the like, which are merely a stylistic form of wording and are not to be construed as limiting the following features to a separate embodiment to all other instances of the same or similar wording. This is to say, a reference to ‘an’, ‘one’ or ‘some’ embodiment(s) may be a reference to any one or more, and/or all embodiments, or combination(s) thereof, disclosed. Also, similarly, the reference to “the” embodiment may not be limited to the immediately preceding embodiment.

As used herein, any machine executable instructions, or compute readable media, may carry out a disclosed method, and may therefore be used synonymously with the term method, or each other.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the present disclosure.

1. A picture frame comprising a picture carrier portion and a frame portion,
the frame portion for formation of a frame and comprising frame members with: a side member hingedly connected via a first hinge connection to the picture carrier portion, and; a back member hingedly connected via a second hinge connection to the side member,
wherein in an assembled configuration: the side member forms a side of the frame portion, and; the back member forms a back of the frame portion and is inclined relative to the picture carrier portion and extends between the side member and the picture carrier portion,
wherein the frame portion includes a carrier portion connecting member, which is connected to the back member,
in the assembled configuration, the carrier portion connecting member to connect the back member to the picture carrier portion, and
the carrier portion connecting member configured to extend from the back member away from the side member.

2. The picture frame of claim 1, wherein in the assembled configuration the back member is inclined relative the picture carrier portion with an interior angle which is acute.

3. The picture frame of either of claim 1, wherein in the assembled configuration, the carrier portion connecting member extends planar to the picture carrier portion.

4. The picture frame of claim 1, wherein the carrier portion connecting member and picture carrier portion are configured to be adhesively connected to each other in the assembled configuration.

5. The picture frame of claim 1, wherein the frame portion includes a guide tab, which is holdable by a user or assembly machine to manipulate the back member to the assembled configuration.

6. The picture frame of claim 1, wherein the picture carrier portion comprises indications to define a position of the carrier portion connecting member/back member in the assembled configuration.

7. The picture frame of claim 1, wherein in the assembled configuration adjoining carrier portion connecting members are arranged to interlock with each other.

8. The picture frame of claim 1, wherein the frame portion has the side portion formed only of the side member and the back portion formed only of the back member.

9. The picture frame of claim 1, wherein adjoining sides of the frame portion are arrangeable in the assembled configuration with the back members to connect to each other.

10. The picture frame of claim 9, wherein a back member includes a back member connecting member, which is arranged to connect to an adjoining back member in the assembled configuration.

11. The picture frame of claim 10, wherein a hinged connection between the back member connecting member and the back member is angled to angle the back member connecting member to correspond to said incline of the adjoining back member in the assembled configuration.

12. The picture frame of claim 10, wherein the back member connecting member and adjoining back member are configured for adhesive connection to each other.

13. The picture frame of claim 1, wherein adjoining back members are configured to interlock with each other in the assembled configuration.

14. The picture frame of claim 13, wherein corresponding engagement portions, which are arranged proximal the side members, of the adjoining back members abut each other along respective edges in the assembled configuration.

15. The picture frame of claim 14, wherein the adjoining back members overlap each other distal the engagement portions, wherein a cut-out portion is disposed between the engagement portion and said overlap.

16. The picture frame of claim 1, formed as a blank from sheet material.

17. The picture frame of claim 1 and a corresponding picture member, the picture frame arranged in the assembled configuration, with the picture member connected to one or more of the: side member; the back member; the picture carrying portion.

18. The picture frame of claim 1 and a closing back member, which is arranged to fit within a cavity which is at least partially bounded/formed by the back members in the assembled configuration,
wherein the closing back member is formed from sheet material and is arrangeable in an assembled configuration in which grooves at corners of said sheet permit aligning of peripheral members to an angle to correspond to said incline of the back members.

19. A method of assembling a picture frame, the method comprising:
hinging a first hinge connection to hinge a side member relative to a picture carrying portion;
hinging a second hinge connection to hinge a back member relative the side member; and
arranging the back member at an incline to the picture carrier member by connecting a carrier portion connecting member to the picture carrier member, with the carrier portion connecting member extending from the back member away from the side member.

20. The method of claim 19, comprising connecting a picture member to at least one of the: side member, and; the back member, prior to hinging said hinge connections.
